(19) United States
(12) Patent Application Publication
(10) Pub. No.: US 2019/0215132 A1
(43) Pub. Date: Jul. 11, 2019

(54) THROUGHPUT GAIN IN NOISY ENVIRONMENTS

(71) Applicant: QUALCOMM Incorporated, San Diego, CA (US)

(72) Inventors: Kiran Babu MALISETTY, Kadiri (IN); Ahmed Ragab ELSHERIF, San Diego, CA (US)

(21) Appl. No.: 16/244,831

(22) Filed: Jan. 10, 2019

(30) Foreign Application Priority Data
Jan. 11, 2018 (IN) 201841001298

(51) Int. Cl. H04L 5/00; H04B 7/0452; H04L 25/02; H04W 74/08; H04W 72/08; H04W 72/12

(52) U.S. Cl. CPC H04L 5/0062; H04B 7/0452; H04L 25/0218; H04W 72/1226; H04L 25/0224; H04W 72/082; H04W 74/0816

(57) ABSTRACT

This disclosure provides systems, devices, apparatus and methods, including computer programs encoded on storage media, for wireless communication. In one aspect, an access point for wireless communications may include a transceiver; a memory; and a processor communicatively coupled to the transceiver and the memory, the processor being configured to: determine an interference level on a selected bandwidth; selectively transmit, via the transceiver, a clear-to-send (CTS)-to-self frame based on the determined interference level; and initiate a sounding sequence based on the transmitted CTS-to-self frame.

### CLAIM OF PRIORITY UNDER 35 U.S.C. § 119

The present Application for Patent claims priority to India Provisional Application No. 201841001298 entitled “IMPROVING THROUGHPUT GAIN IN NOISY ENVIRONMENTS” filed Jan. 11, 2018, and assigned to the assignee hereof and hereby expressly incorporated by reference herein.

### TECHNICAL FIELD

This disclosure relates generally to wireless communications, and more specifically, to improving throughput gain in noisy environments.

### DESCRIPTION OF THE RELATED TECHNOLOGY

The deployment of WLANs in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs. In some scenarios, communications that occur in nearby BSSs can result in collisions and failure in the transmission of information.

In dense enterprise deployments of WLANs, such as in stadiums, airports, or other large venues, for example, there may be multiple APs deployed, and the coverage of several of those APs can overlap creating OBSS scenarios. For example, in these dense deployments, multiple STAs can be in the common coverage of multiple BSSs. Moreover, when these dense deployments are unplanned, some of the APs may be automatically configured to work on the same channel, which may cause transmission collisions between OBSSs. The collisions that occur may result in sounding sequence failures and, upon detection of a sounding sequence failure, an AP may terminate a transmission opportunity (TxOP) and would need to contend for the medium again. When this happens frequently, this is known as a noisy environment. In noisy environments, system throughput can be severely impacted.

Accordingly, in noisy environments that have OBSSs between nearby BSSs and that can result in sounding sequence collisions and failures, throughput gain improvements are desired.

### SUMMARY

The systems, methods and devices of this disclosure each have several innovative aspects, no single one of which is solely responsible for the desirable attributes disclosed herein.

One innovative aspect of the subject matter described in this disclosure can be implemented in an access point for wireless communication. In some implementations, the access point can include a transceiver; a memory; and a processor communicatively coupled to the transceiver and the memory, the processor being configured to: determine an interference level on a selected bandwidth; selectively transmit, via the transceiver, a clear-to-send (CTS)-to-self frame on the selected bandwidth based on the determined interference level; and initiate a sounding sequence based on the transmitted CTS-to-self frame.

In some implementations, the processor can be configured to initiate the sounding sequence on a bandwidth determined by a clear channel assessment (CCA) for the CTS-to-self frame. In some implementations, the processor can be configured to select a different bandwidth than the selected bandwidth to initiate the sounding sequence based on a CCA for the CTS-to-self frame. In some implementations, the sounding sequence can comprise: transmitting a null data packet announcement (NDPA) frame; and transmitting a null data packet (NDP) frame. In some implementations, the processor can be configured to initiate a steering sequence after completion of the sounding sequence, the steering sequence being addressed to a plurality of stations (STAs) in a multi-user multiple-input-multiple-output (MU-MIMO) group.

In some implementations, the processor can be configured to compare the determined interference level to a predetermined threshold value preprogrammed into the memory. In some implementations, the processor can be configured to enable the transmission of the CTS-to-self frame if the determined interference level is greater than the predetermined threshold value for a consecutive number of times preprogrammed into the memory. In some implementations, the processor can be configured to disable the transmission of the CTS-to-self frame if the determined interference level is less than the predetermined threshold value. In some implementations, the processor can be configured to disable the transmission of the CTS-to-self frame if the determined interference level is greater than the predetermined threshold value for less than the consecutive number of times.

In some implementations, the processor can be configured to poll clear channel assessment (CCA) registers to determine the interference level on the selected bandwidth. In some implementations, the determined interference level can correspond to a level of interference from a second access point transmitting on the selected bandwidth. In some implementations, the processor can be configured to set a value of an interference flag to one when the determined interference level is greater than the predetermined threshold value for the consecutive number of times. In some implementations, the processor can be configured to enable the transmission of the CTS-to-self frame when the value of the interference flag is set to one. In some implementations, the processor can be configured to bypass the transmission of the CTS-to-self frame when the value of the interference flag is set to zero.

Another innovative aspect of the subject matter described in this disclosure can be implemented in a method for wireless communications. In some implementations, the method can include determining, at an access point, an interference level on a selected bandwidth; selectively transmitting, from the access point, a clear-to-send (CTS)-to-self frame on the selected bandwidth based on the determined interference level; and initiating, at the access point, a sounding sequence based on the transmitted CTS-to-self frame.

In some implementations, the method can further include initiating the sounding sequence on a bandwidth determined by a clear channel assessment (CCA) for the CTS-to-self frame. In some implementations, the method can further include selecting a different bandwidth than the selected bandwidth to initiate the sounding sequence based on a CCA for the CTS-to-self frame. In some implementations, initiating the sounding sequence can further include: transmitting a null data packet announcement (NDPA) frame; and transmitting a null data packet (NDP) frame. In some implementations, the method can further include initiating a steering sequence after completion of the sounding sequence, the steering sequence being addressed to a plurality of stations (STAs) in a multi-user multiple-input-multiple-output (MU-MIMO) group.

In some implementations, the method can further include comparing the determined interference level to a predetermined threshold value. In some implementations, the method can further include enabling the transmission of the CTS-to-self frame if the determined interference level is greater than the predetermined threshold value for a consecutive number of times. In some implementations, the method can further include disabling the transmission of the CTS-to-self frame if the determined interference level is less than the predetermined threshold value. In some implementations, the method can further include disabling the transmission of the CTS-to-self frame if the determined interference level is greater than the predetermined threshold value for less than the consecutive number of times.

In some implementations, the method can further include polling clear channel assessment (CCA) registers to determine the interference level on the selected bandwidth. In some implementations, the determined interference level can correspond to a level of interference from a second access point transmitting on the selected bandwidth. In some implementations, the method can further include setting a value of an interference flag to one when the determined interference level is greater than the predetermined threshold value for the consecutive number of times. In some implementations, the method can further include enabling the transmission of the CTS-to-self frame when the value of the interference flag is set to one. In some implementations, the method can further include bypassing the transmission of the CTS-to-self frame when the value of the interference flag is set to zero.

Another innovative aspect of the subject matter described in this disclosure can be implemented in a wireless communications device. In some implementations, the wireless communications device can include means for determining an interference level on a selected bandwidth; means for selectively transmitting a clear-to-send (CTS)-to-self frame on the selected bandwidth based on the determined interference level; and means for initiating a sounding sequence based on the transmitted CTS-to-self frame.

Another innovative aspect of the subject matter described in this disclosure can be implemented in a non-transitory computer-readable storage medium.

In some implementations, the non-transitory computer-readable storage medium can include storing instructions that, when executed by one or more processors of a wireless communications device, cause the wireless communications device to: determine an interference level on a selected bandwidth; selectively transmit a clear-to-send (CTS)-to-self frame on the selected bandwidth based on the determined interference level; and initiate a sounding sequence based on the transmitted CTS-to-self frame.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a conceptual diagram illustrating an example of a wireless local area network (WLAN) deployment in accordance with various aspects of the present disclosure.

FIG. 2 is a schematic diagram of a communication network including aspects of an access point in a WLAN in accordance with various aspects of the present disclosure.

FIG. 3 is a diagram illustrating an example of a MU-MIMO sounding sequence in accordance with various aspects of the present disclosure.

FIG. 4 is a flow diagram illustrating an example of a method for wireless communications in accordance with various aspects of the present disclosure.

FIG. 5 is a flow diagram illustrating an example of a method for wireless communications in accordance with various aspects of the present disclosure.

FIG. 6 is a flow diagram illustrating an example of a method for wireless communications in accordance with various aspects of the present disclosure.

Like reference numerals refer to corresponding parts throughout the drawing figures.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, or 5G, or further implementations thereof, technology.

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the features described. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct—sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and may be used to transmit wireless signals across a relatively long range, for example about one kilometer or longer.

In some implementations, a WLAN includes various devices, which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (such as the IEEE 802.11 protocol) compliant wireless link to obtain general connectivity to the Internet or to other wide area networks. In some implementations, a STA may also be used as an AP.

An AP may also include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also include, be implemented as, or known as an access terminal (AT), a subscriber station, a subscriber unit, a mobile station, a remote station, a remote terminal, a user terminal, a user agent, a user device, a user equipment, or some other terminology. In some implementations, a station may include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that utilizes an “association request” by one of the apparatus followed by an “association response” by the other apparatus. It will be understood by those skilled in the art that the handshake protocol may utilize other signaling, such as by way of example, signaling to provide authentication.

In dense enterprise deployments of WLANs, such as in stadiums, airports, or other large venues, there may be multiple APs deployed, and the coverage of several of those APs can overlap creating OBSS scenarios. In these dense deployments, multiple STAs can be in the common coverage of multiple BSSs. Moreover, when these dense deployments are unplanned, some of the APs may be automatically configured to work on the same channel, which may cause collisions between OBSSs.

For single user (SU) transmissions in WLAN, a sounding sequence may refer to a sequence of messages or information used to generate beam-forming based on explicit knowledge of the forward channel that is being used. The beam-forming may then be used to more effectively communicate by adapting the signal transmission using multiple antennas. The sounding sequence may involve the transmission of a null data packet (NDP) or a null data packet announcement (NDPA) before an NDP to obtain feedback information needed for beam-forming (typically one NDPA and one NDP are sent per sounding sequence). The sounding sequence may also involve the transmission of compressed beam-forming feedback (CBF) and/or beam-forming report poll (BRPoll).

MU-MIMO communications are typically provided to multiple STAs, where an AP may transmit to a full set of STAs that have participated in a sounding sequence or to a subset of the STAs that participated in the sounding sequence (an AP may still chose to transmit to a single STA after a MU-MIMO sounding sequence). For MU-MIMO transmissions, however, the WLAN standards up to IEEE 802.11ac have not defined a specific mechanism that may be used for MU-MIMO sounding sequence protection.

For MU-MIMO transmissions in OBSS scenarios like the ones described above, not protecting the MU-MIMO sounding sequence may result in collision of the sounding sequence and in a sounding sequence failure. Upon the detection of sounding failure (i.e., no CBF received after the NDP), the AP will terminate the transmission opportunity (TxOP) and will have to contend for the medium again. Since the TxOP is lost on sounding sequence failure, the system throughput can be severely impacted if this happens frequently, which can be the case in the OBSS scenarios described above. Typically, upon detection of a sounding sequence failure, and after random backoff (RBO), the AP will either retry the sounding sequence and the MU-MIMO transmission, or will try a new set of MU-MIMO STAs. Again, either of these operations results in reduced system throughput. Accordingly, it is desirable to develop effective ways to protect MU-MIMO sounding sequence in OBSS scenarios.

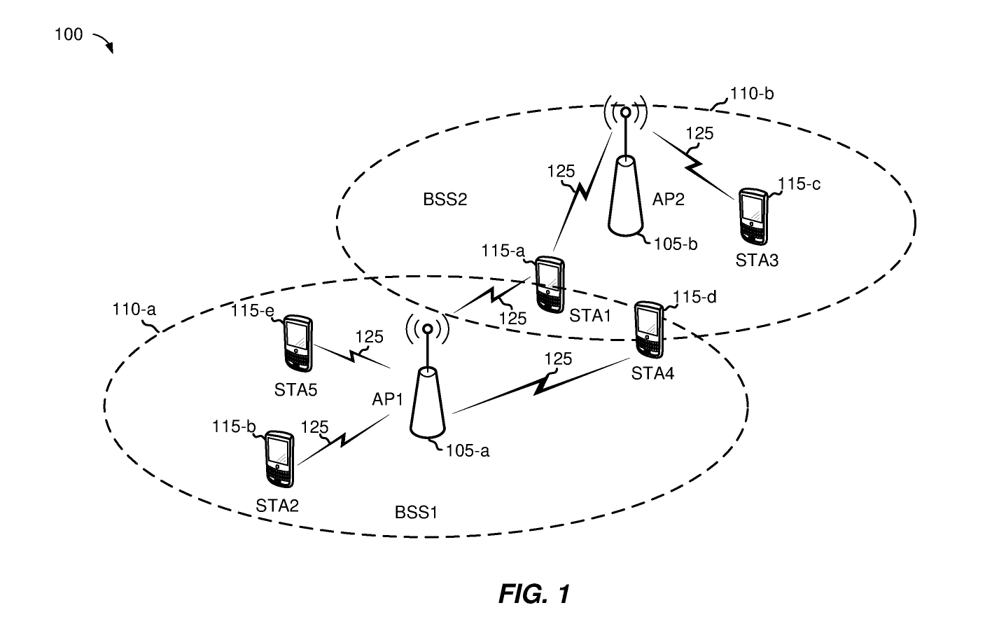

FIG. 1 is a wireless communication system 100 illustrating an example of a wireless local area network (WLAN) deployment in connection with various techniques described herein. The WLAN deployment may include one or more access points (APs) and one or more wireless stations (STAs) associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a, STA2 115-b, STA4 115-d, and STA5 115-e) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for scheduling and grouping users or STAs for data transmission over an OFDMA frame may be applicable to any suitable wireless network regardless of the coverage range and the wireless access protocols utilized.

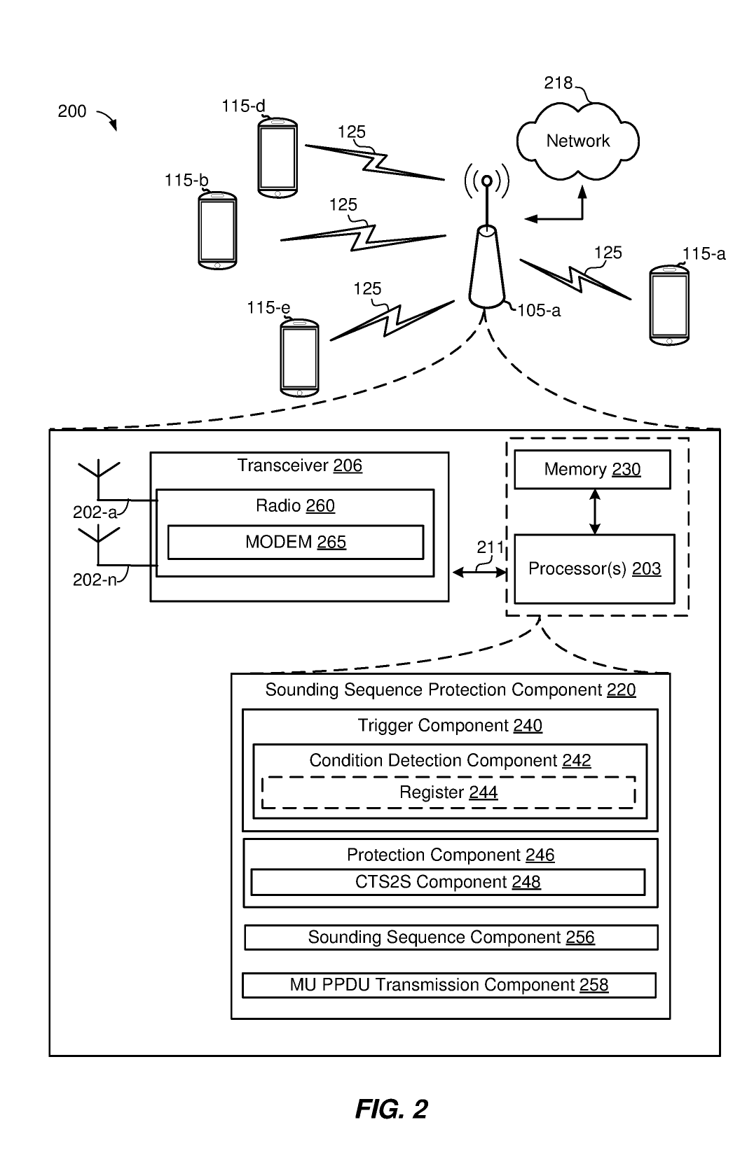

In an aspect, an AP, such as AP1 105-a, may communicate with multiple STAs, such as STAs 115-a, 115-b, 115-d, and 115-e using MU-MIMO. Such a group may be referred to as a MU-MIMO group. The proximity of AP2 105-b (BSS2) to BSS1 may create an OBSS scenario like the ones described above. In such scenario, the MU-MIMO sounding sequence used by AP1 105-a in connection with an MU-MIMO group may have collisions or interference from AP2 105-b in BSS2. These collisions may result in sounding sequence failures and can significantly impact system throughput. To overcome the possible effects from interference by AP2 105-b in BSS2, AP1 105-a may perform the various techniques described herein to protect the MU-MIMO sounding sequence. Additional details as to the operation of AP1 105-a are provided below in connection with FIGS. 2-6.

Referring to FIG. 2, in an aspect, a wireless communication system 200 includes STAs 115-a, 115-b, 115-d, and 115-e in wireless communication with at least one AP, such as AP1 105-a connected to network 218, similar to STAs 115-a, 115-b, 115-d, and 115-e, and AP1 105-a of FIG. 1. The STAs 115-a, 115-b, 115-d, and 115-e may communicate with network 218 via AP1 105-a. In an example, STAs 115-a, 115-b, 115-d, and 115-e may transmit and/or receive wireless communication to and/or from AP1 105-a via one or more communication links 125. Such wireless communications may include, but are not limited to, data, audio and/or video information. In some instances, such wireless communications may include control or similar information. In an aspect, an AP, such as AP1 105-a may be configured to perform an MU-MIMO sounding sequence for an MU-MIMO group including multiple STAs, such as STAs 115-a, 115-b, 115-d, and 115-e. In OBSS scenarios, the AP1 105-a may perform techniques to protect the MU-MIMO sounding sequence from interference by nearby APs to reduce the number of sounding sequence failures and improve system throughput.

In accordance with the present disclosure, AP1 105-a may include a memory 230, one or more processors 203 and a transceiver 206. The memory, one or more processors 203 and the transceiver 206 may communicate internally via a bus 211. In some examples, the memory 230 and the one or more processors 203 may be part of the same hardware component (e.g., may be part of a same board, module, or integrated circuit). Alternatively, the memory 230 and the one or more processors 203 may be separate components that may act in conjunction with one another. In some aspects, the bus 211 may be a communication system that transfers data between multiple components and subcomponents of the AP1 105-a. In some examples, the one or more processors 203 may include any one or combination of modem processor, baseband processor, digital signal processor, and/or transmit processor. Additionally or alternatively, the one or more processors 203 may include a sounding sequence protection component 220 for carrying out one or more methods or procedures described herein. The sounding sequence protection component 220 may comprise hardware, firmware, and/or software and may be configured to execute code or perform instructions stored in a memory (e.g., a computer-readable storage medium).

In some examples, the AP1 105-a may include the memory 230, such as for storing data used herein and/or local versions of applications or sounding sequence protection component 220 and/or one or more of its subcomponents being executed by the one or more processors 203. Memory 230 can include any type of computer-readable medium usable by a computer or processor 203, such as random access memory (RAM), read only memory (ROM), tapes, magnetic discs, optical discs, volatile memory, non-volatile memory, and any combination thereof. In an aspect, for example, memory 230 may be a computer-readable storage medium (e.g., a non-transitory medium) that stores computer-executable code. The computer-executable code may define one or more operations or functions of sounding sequence protection component 220 and/or one or more of its subcomponents, and/or data associated therewith. The computer-executable code may define these one or more operations or functions when AP1 105-a is operating processor 203 to execute sounding sequence protection component 220 and/or one or more of its subcomponents. In some examples, the AP1 105-a may further include a transceiver 206 for transmitting and/or receiving one or more data and control signals to/from an STA, such as 115-a, 115-b, 115-d, and 115-e. The transceiver 206 may comprise hardware, firmware, and/or software and may be configured to execute code or perform instructions stored in a memory (e.g., a computer-readable storage medium). The transceiver 206 may include multiple radios and modems including radio 260 comprising a modem 265. In an aspect, AP1 105-a and transceiver 206 supports MU-MIMO that enables multiple wireless connections such as a wireless local area network (WLAN) or a short distance communication protocol (e.g., Bluetooth radio) with a plurality of STAs, such as STAs 115-a, 115-b, 115-d, and 115-e. The radio 260 may utilize one or more antennas 202 (e.g., antennas 202-a, . . . , 202-n) for transmitting signals to and receiving signals from a plurality of STAs, such as STAs 115-a, 115-b, 115-d, and 115-e. The signals transmitted and/or received may include frames or other messages and information used in MU-MIMO sounding sequences. The transceiver 206 may include a receiver and a transmitter, which may be part of the radio 260 and/or part of the modem 265. The receiver may include one or more components that form a receiving chain and the transmitter may include one or more components that form a transmitting chain.

In an aspect, AP1 105-a may include the sounding sequence protection component 220 having a trigger component 240 that is configured to trigger the use of MU-MIMO sounding sequence protection. For example, the trigger component 240 may be configured to detect a condition associated with OBSS scenarios that are likely to result in sounding sequence failures because of collisions or interference. As such, the trigger component may include a condition detection component 242 that may carry out such detection. The detection may be based on a register setting (e.g., setting optional register 244) that indicates that the AP1 105-a is to operate in an OBSS scenario. This register setting may have been set manually based on the type of deployment of the AP1 105-a. The detection may also be based on detecting an OBSS scenario based on, for example, receiving an OBSS frame.

In another aspect, the detection may be based on a register setting (e.g., setting optional register 244) that indicates an interference level on a selected bandwidth. The interference level may be determined by Clear Channel Assessment (CCA) statistics that are stored in one or more registers, such as optional register 244. For instance, AP 105-a may perform a CCA to determine whether the selected bandwidth is available for transmission of a current frame. The CCA is a physical carrier sense that senses received energy on the selected bandwidth and indicates whether the selected bandwidth is a busy or idle medium for the current frame. The CCA includes carrier sensing and energy detection, and statistics from these functions may be stored in hardware registers, such as the optional register 244. The one or more registers, such as optional register 244, may include at least one counter configured to keep track of the CCA statistics.

The condition detection component 242 may periodically poll the one or more registers, such as the optional register 244, to determine the interference level on the selected bandwidth. The condition detection component 242 may detect an OBSS scenario condition, for example, if the determined interference level is greater than a predetermined threshold value for a consecutive number of times. This condition may be preprogrammed into the memory 230 of the AP 105-a, and detection of this condition may trigger the use of the MU-MIMO sounding sequence protection by the trigger component 240.

The predetermined threshold that the determined interference level is compared to may be a programmable design parameter defined by, for example, a historic channel occupancy time or other metric. The consecutive number of times may be a programmable parameter that relates to a most recent number of transmissions wherein the determined interference level is consecutively greater than the predetermined threshold. In addition, values for the programmable parameters of the predetermined threshold and the consecutive number of times the determined interference level is greater than the predetermined threshold value may be determined by aggressive or conservative requirements of the AP 105-a in terms of reducing the overhead of the MU-MIMO sounding sequence protection. However, other programmable parameters and other OBSS scenario conditions may be used to trigger the use of the MU-MIMO sounding sequence.

Furthermore, if the OBSS scenario condition is satisfied, an interference flag (or other value) may be set to one, thereby triggering the use of the MU-MIMO sounding sequence. When the interference flag is set to one, this may indicate that the AP 105-a is operating in a noisy environment with an OBSS. If the OBSS scenario condition is not satisfied, the interference flag (or other value) may be set to zero, and the use of the MU-MIMO sounding sequence may not be triggered. When the interference flag is set to zero, this may indicate that the AP 105-a is operating in a normal environment without an OBSS. However, other configurations may be used to trigger the use of the MU-MIMO sounding sequence.

In another aspect, sounding sequence protection component 220 may include a protection component 246 configured to perform MU-MIMO sounding sequence protection in the appropriate scenarios (e.g., when the OBSS scenario condition is detected and protection is triggered). The protection component 246 may be enabled in OBSS or similar interference scenarios. For example, the operation of the protection component 246 may be triggered by the trigger component 240 in response to the detection of the determined interference level being greater than the predetermined threshold value for the consecutive number of times. In so doing, the protection component 246 may be triggered only when the AP 105-a is operating in a noisy environment. As a result, an overhead of the MU-MIMO sounding sequence protection may be reduced and a throughput gain in noisy environments may be improved without impacting performance of the AP 105-a in normal environments.

The protection component 246 may include a clear-to-send-to-self (CTS2S) component 248 configured to generate CTS2S frames. The CTS2S component 248 may transmit a CTS2S frame on the selected bandwidth. Transmission of a CTS2S frame may obtain real time channel conditions of the selected bandwidth, such as confirmation of the availability of the selected bandwidth. Real time information about the channel interference may be obtained to dynamically adapt to an appropriate bandwidth. More specifically, a CCA during transmission of a CTS2S frame may be performed to select a bandwidth for the MU-MIMO sounding sequence. Based on the CCA for the transmitted CTS2S frame, the MU-MIMO sounding sequence may be transmitted on the same selected bandwidth or on a different bandwidth than the selected bandwidth for the CTS2S frame.

The sounding sequence protection component 220 may also include a sounding sequence component 256 that is configured to initiate a MU-MIMO sounding sequence in connection with the CTS2S protection provided by the protection component 246 in OBSS scenarios. The sounding sequence component 256 may be configured to receive information indicative of a channel and bandwidth on which transmission of the CTS2S frame occurred. For instance, the CTS2S component 248 may queue a CTS2S frame on a first channel of the selected bandwidth. A CCA for the CTS2S frame may indicate an availability of the first channel. If the first channel is available as determined by CCA statistics, hardware of the AP 105-a may transmit the queued CTS2S frame on the first channel. If the first channel is unavailable due to interference as determined by CCA statistics, such CCA statistics may also indicate a second channel that is available. Hardware of the AP 105-a may transmit the queued CTS2S frame on the second channel if the first channel is unavailable.

The sounding sequence component 256 may be notified of the channel, e.g. the first channel or the second channel, on which transmission of the queued CTS2S frame occurred. The channel on which transmission of the CTS2S frame occurred may indicate and confirm availability of that channel for the MU-MIMO sounding sequence. In addition, transmission of the CTS2S frame on the channel may reserve medium access on such channel for transmission of the MU-MIMO sounding sequence for a time period indicated by a duration field of the CTS2S frame. In so doing, transmission of the CTS2S frame protects the MU-MIMO sounding sequence and improves MU throughput gain.

In an example, the CTS2S component 248 may queue a CTS2S frame on a secondary channel of the selected bandwidth, such as on an 80 MHz channel. If the 80 MHz channel is available, CCA statistics will indicate such, and hardware of the AP 105-a will transmit the CTS2S frame on the 80 MHz channel. The sounding sequence component 256 may be notified of the CTS2S frame transmission on the 80 MHz channel and may, therefore, initiate the MU-MIMO sounding sequence on the 80 MHz channel.

Continuing the example, on the other hand, the 80 MHz channel may be unavailable for transmission of the CTS2S frame due to interference and only a primary 20 MHz channel may be available. CCA statistics will indicate that the 80 MHz channel is unavailable and that the 20 MHz channel is available, and hardware of the AP 105-a will transmit the CTS2S frame on the 20 MHz channel instead of the 80 MHz channel. The sounding sequence component 256 will be notified of the CTS2S frame transmission on the 20 MHz channel and may, therefore, initiate the MU-MIMO sounding sequence on the 20 MHz channel. It is to be understood that the secondary 80 MHz channel and the primary 20 MHz channel were used above for example purposes only and that the sounding sequence protection component 220 may be applied to any primary channel, secondary channel, 20 MHz channel, 40 MHz channel, 80 MHz channel, 160 MHz channel, etc.

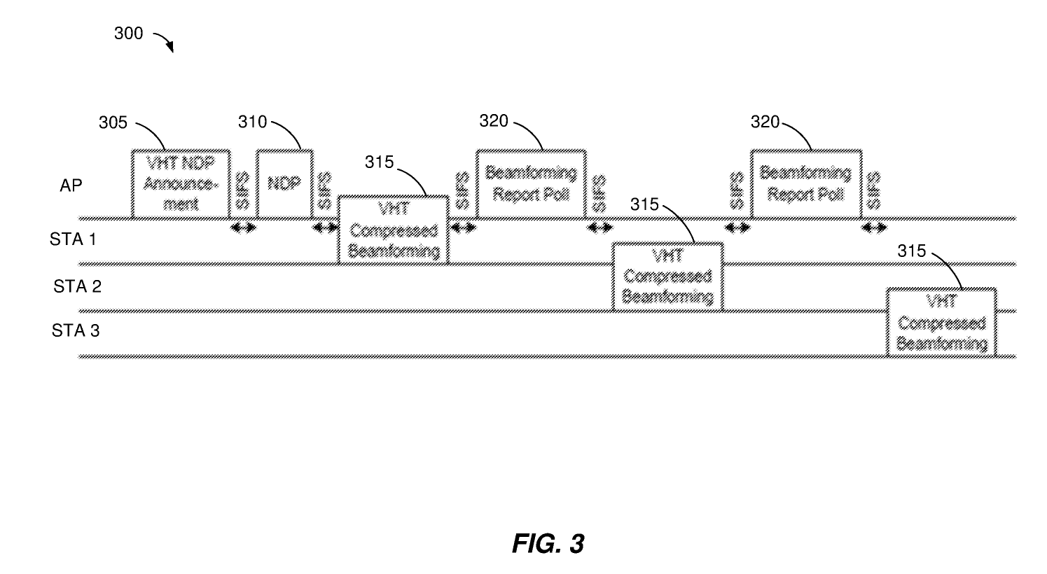

Furthermore, the sounding sequence component 256 may generate and send the MU-MIMO sounding sequence to STAs in an MU-MIMO group. FIG. 3 is a diagram 300 showing an example MU-MIMO sounding sequence. The MU-MIMO sounding sequence may include an NDPA 305, an NDP 310, CBF 315 from each of the STAs in the MU-MIMO group, and BRPoll 320. However, other configurations for the MU-MIMO sounding sequence may be used.

Referring back to FIG. 2, the sounding sequence component 256 may generate and send NDPAs and NDPs to STAs in an MU-MIMO group, and may receive and process CBFs from one or more of the STAs in the MU-MIMO group. The sounding sequence component 256 may also generate and send BRPolls, similar to generating and sending NDPAs and NDPs. With the information provided by the MU-MIMO sounding sequence, the AP1 105-a may configure the transmission of MU-MIMO data over the multiple antennas 202-a, . . . , 202-n. For example, the sounding sequence protection component 220 may also include an MU PPDU transmission component 258 configured to perform data transmission of MU-MIMO data (e.g., PPDUs) over multiple antennas. The MU PPDU transmission component 258 may operate in connection with the transceiver 206. After completion of the MU-MIMO sounding sequence, the MU PPDU transmission component 258 may initiate a steering sequence. The steering sequence may be transmitted and addressed to STAs in the MU-MIMO group. For example, the MU PPDU transmission component 258 may transmit MU-MIMO data using a transmitter in the transceiver 206.

It is to be understood that although described herein within the context of MU-MIMO communications, various implementations of the sounding sequence protection may also be applicable to single user (SU) communications, such as to communications between one and only one STA and one and only one AP. Furthermore, various implementations of the sounding sequence protection may be applicable to downlink and/or uplink communications whether in MU communications or SU communications.

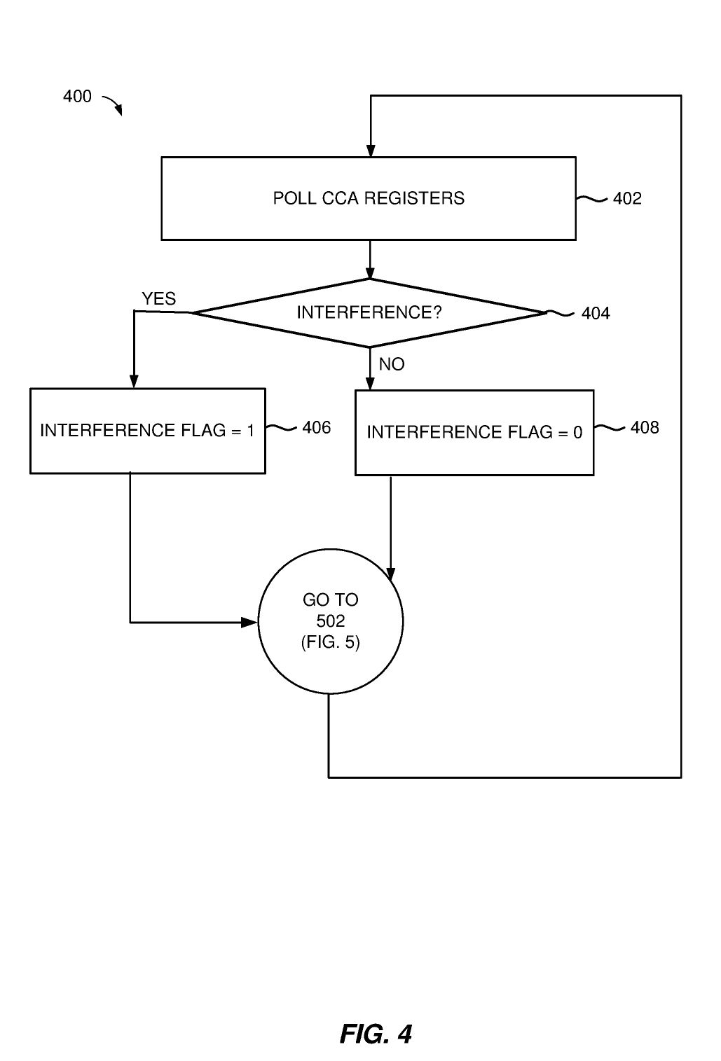

Referring to FIGS. 4-6, examples of one or more operations related to the sounding sequence protection component 220 (FIG. 2) according to the present apparatus and methods are described with reference to one or more methods and one or more components. Although the operations described below are presented in a particular order and/or as being performed by an example component, it should be understood that the ordering of the actions and the components performing the actions may be varied, depending on the implementation. Also, although the sounding sequence protection component 220 is illustrated as having a number of subcomponents, it should be understood that one or more of the illustrated subcomponent may be separate from, but in communication with, the sounding sequence protection component 220 and/or each other. Moreover, it should be understood that the following actions or components described with respect to the sounding sequence protection component 220 and/or its subcomponents may be performed by a specially-programmed processor, a processor executing specially-programmed software or computer-readable media, or by any other combination of a hardware component and/or a software component specially configured for performing the described actions or components. For example, various aspects of the operation of the sounding sequence protection component 220 and/or its subcomponents may be performed by, or implemented in, the processor 203 in FIG. 2.

Referring to FIG. 4, a flow diagram is shown illustrating a method 400 for monitoring interference conditions, such as for determining the interference level on the selected bandwidth. The method may include, at block 402, polling CCA registers to determine the interference level on the selected bandwidth. In an aspect, the sounding sequence protection component 220, the trigger component 240, the condition detection component 242, and/or the processor 203 may poll the one or more registers, such as the optional register 244, to obtain the CCA statistics on the selected bandwidth.

At block 404, the method 400 may determine whether there is interference on the selected bandwidth, such as in an OBSS scenario. In the OBSS scenario, the determined interference level may correspond to a level of interference from a second AP, such as AP2 105-b, transmitting on the selected bandwidth. The determined interference level may be compared to a predetermined threshold value. In addition, a consecutive number of times the determined interference level is consistently greater than the predetermined threshold value may be monitored. In an aspect, the sounding sequence protection component 220, the trigger component 240, the condition detection component 242, and/or the processor 203 may detect or identify a condition that indicates an OBSS or similar interference scenario.

At block 406, if there is interference on the selected bandwidth, such as in an OBSS scenario, then a value of the interference flag is set to one. For example, the value of the interference flag may be set to one when the determined interference level is greater than the predetermined threshold value for the consecutive number of times. In an aspect, the sounding sequence protection component 220, the trigger component 240, the condition detection component 242, the register 244, and/or the processor 203 may set the interference flag to one when a condition is detected or identified that indicates an OBSS or similar interference scenario.

At block 408, if there is no interference on the selected bandwidth, then the value of the interference flag is set to zero. For example, the value of the interference flag may be set to zero when the determined interference level is less than the predetermined threshold value and/or if the determined interference level is greater than the predetermined threshold for less than the consecutive number of times. In an aspect, the sounding sequence protection component 220, the trigger component 240, the condition detection component 242, the register 244, and/or the processor 203 may set the interference flag to zero when a condition has not been detected or identified that indicates an OBSS or similar interference scenario.

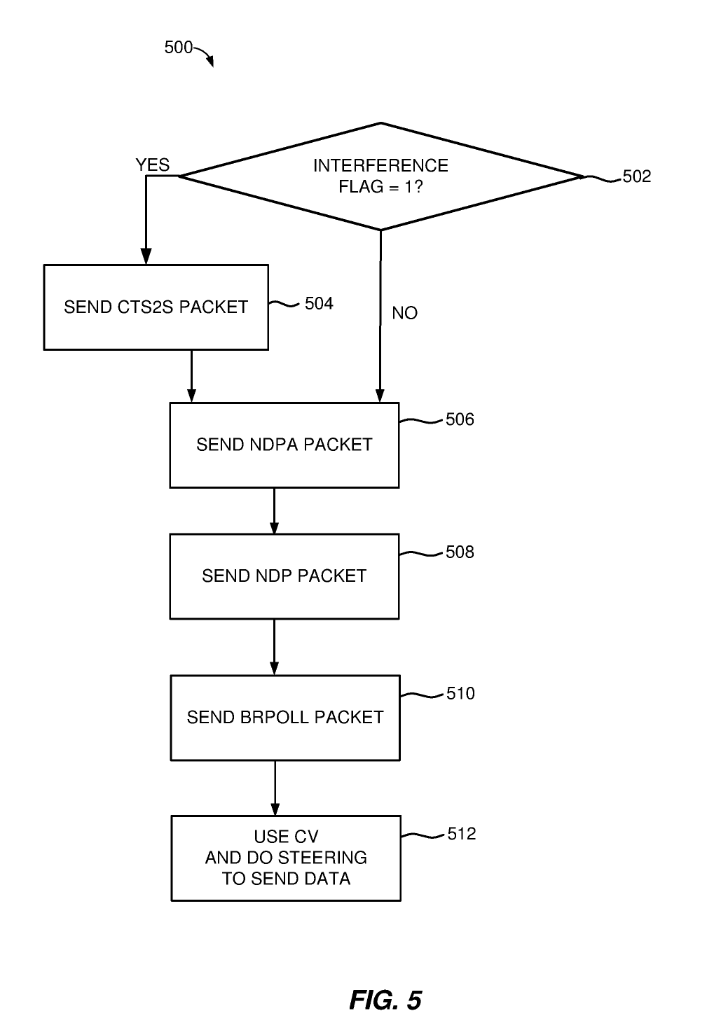

Referring to FIG. 5, a flow diagram is shown illustrating a method 500 for MU-MIMO sounding with CTS2S protection. The method 500 may include, at block 502, determining whether there is interference on the selected bandwidth and/or if a condition that indicates an OBSS or similar interference scenario has been detected or identified. For example, the method 500 may determine whether the value of the interference flag is set to one. In an aspect, the sounding sequence protection component 220, the trigger component 240, the condition detection component 242, the register 244, and/or the processor 203 may determine whether MU-MIMO sounding sequence protection using CTS2S frames is needed.

At block 504, a CTS2S frame may be transmitted on the selected bandwidth based on the determined interference level, such as if MU-MIMO sequence sounding protection is needed. For example, if the value of the interference flag is set to one, then transmission of the CTS2S frame may be enabled, such as if the determined interference level is greater than the predetermined threshold value for the consecutive number of times. In an aspect, the sounding sequence protection component 220, the protection component 246, the CTS2S component 248, the processor 203, and/or the transceiver 206 may generate and send the CTS2S frame on the selected bandwidth based on the determined interference level.

At block 506, a MU-MIMO sounding sequence may be initiated based on the transmitted CTS2S frame. If, at block 502, there is no interference on the selected bandwidth and/or if a condition that indicates an OBSS or similar interference scenario has not been detected or identified, then the method 500 may proceed directly to block 506, and the MU-MIMO sounding sequence is initiated on the selected bandwidth without transmission of a CTS2S frame. More specifically, the transmission of the CTS2S frame may be disabled if MU-MIMO sounding protection using CTS2S is unnecessary. For instance, the transmission of the CTS2S frame may be disabled if the determined interference level is less than the predetermined threshold value. The transmission of the CTS2S frame may also be disabled if the determined interference level is greater than the predetermined threshold value for less than the consecutive number of times. The value of the interference flag may be set to zero, and the transmission of the CTS2S frame may be bypassed. Accordingly, the MU-MIMO sounding sequence may be initiated on the selected bandwidth without transmission of the CTS2S frame. This may reduce overhead by eliminating transmission of a CTS2S frame for scenarios with no or little interference, such as in normal environments that do not have an OBSS.

If, at block 504, a CTS2S frame was transmitted, then, at block 506, the MU-MIMO sounding sequence is initiated on a bandwidth determined by a CCA for the CTS2S frame. For example, if CCA statistics for the CTS2S frame indicate that the selected bandwidth is available, the CTS2S frame will be transmitted on the selected bandwidth, and it may be determined that the selected bandwidth is available for the MU-MIMO sounding sequence. Therefore, the MU-MIMO sounding sequence may be initiated on the selected bandwidth. Continuing the example, if CCA statistics for the CTS2S frame indicate that the selected bandwidth is unavailable, the CTS2S frame will not be transmitted on the selected bandwidth. The MU-MIMO sounding sequence may be initiated on a bandwidth determined by the CCA for the CTS2S frame. If the selected bandwidth is unavailable, a different bandwidth than the selected bandwidth may be selected to initiate the sounding sequence based on the CCA for the CTS2S frame.

For instance, CCA statistics for the CTS2S frame may indicate a different channel and/or bandwidth than the selected bandwidth for transmission of the CTS2S frame. After transmission of the CTS2S frame on the different channel and/or bandwidth, it may be determined that the different channel and/or bandwidth is available for the MU-MIMO sounding sequence, and the MU-MIMO sounding sequence may be transmitted on the different channel and/or bandwidth. In so doing, the transmission of the CTS2S frame may confirm availability of the selected bandwidth or the different channel and/or bandwidth, thereby providing protection for the MU-MIMO sounding sequence. Accordingly, MU throughput gain may be improved, such as in noisy environments. Initiation of the MU-MIMO sounding sequence, at block 506, may include generating and transmitting an NDPA frame to one or more STA in an MU-MIMO group. In an aspect, the sounding sequence protection component 220, the sounding sequence component 256, the processor 203, and/or the transceiver 206 may initiate and perform the MU-MIMO sounding sequence based on the transmitted CTS2S frame, such as by transmitting the NDPA frames.

At block 508, an NDP frame may be generated and transmitted to one or more of the STAs in the MU-MIMO group. The transmission of the NDP frames may be part of the MU-MIMO sounding sequence. In an aspect, the sounding sequence protection component 220, the sounding sequence component 256, the processor 203, and/or the transceiver 206 may perform the MU-MIMO sounding sequence, including transmitting the NDP frames.

At block 510, a BRPoll frame may be generated and transmitted to one or more of the STAs in the MU-MIMO group. The transmission of the BRPoll frames may be part of the MU-MIMO sounding sequence. In an aspect, the sounding sequence protection component 220, the sounding sequence component 256, the processor 203, and/or the transceiver 206 may perform the MU-MIMO sounding sequence, including transmitting the BRPoll frames.

At block 512, a steering sequence may be initiated after completion of the sounding sequence. The steering sequence may be addressed to one or more of the STAs in the MU-MIMO group. For instance, compressed beamforming reports (CV) may be used and the steering sequence may be performed to transmit MU-MIMO data over multiple antennas. More specifically, compressed beamforming reports (CV) may be received and processed from one or more of the STAs in the MU-MIMO group, such as in between blocks 508 and 510. At block 512, the CV may then be used to perform the steering sequence. The steering sequence may include transmitting MU-MIMO data communications to one or more STAs in the MU-MIMO group, such as data transmission and data transmission with one or more STAs in the MU-MIMO group. In an aspect, the sounding sequence protection component 220, the MU PPDU transmission component 258, the processor 203, and/or the transceiver 206 may initiate and perform the steering sequence.

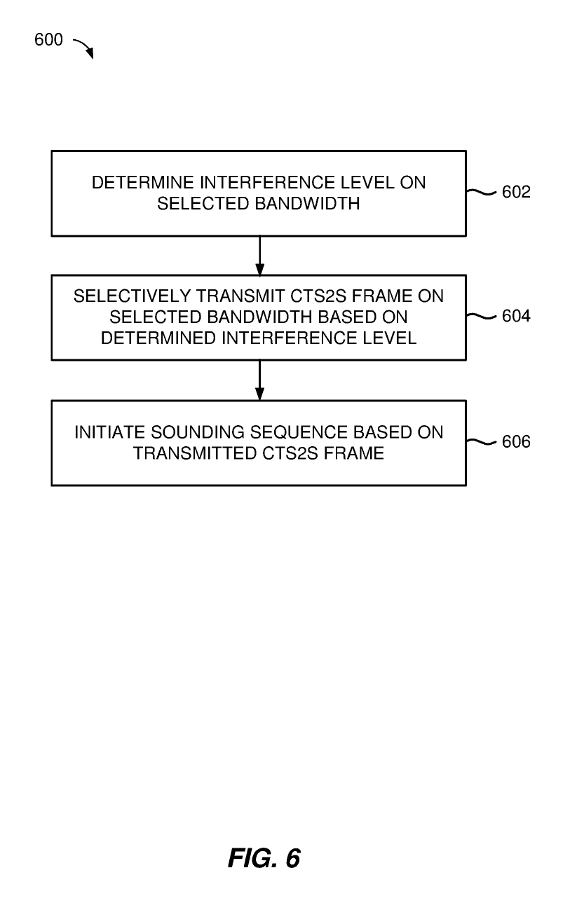

Referring to FIG. 6, a flow diagram is shown illustrating a method 600 for improving throughput gain in noisy environments via MU-MIMO sounding sequence protection using a CTS2S frame. At block 602, an AP, such as the AP1 105-a, may determine an interference level on a selected bandwidth. In an aspect, the sounding sequence protection component 220, the trigger component 240, the condition detection component 242, the protection component 246, and/or the processor 203 may determine the interference level on the selected bandwidth.

At block 604, the AP, such as the AP1 105-a, may selectively transmit a CTS2S frame on the selected bandwidth based on the determined interference level. Depending on what the determined interference level is, the AP may or may not transmit the CTS2S frame on the selected bandwidth. A processor, such as the processor 203, of the AP may compare the determined interference level to a predetermined threshold value preprogrammed into a memory associated with the processor, such as the memory 230 associated with the processor 203. The processor may enable the transmission of the CTS2S frame by the AP if the determined interference level is greater than the predetermined threshold value for a consecutive number of times preprogrammed into the memory. The processor may disable the transmission of the CTS2S frame by the AP if the determined interference level is less than the predetermined threshold value or if the determined interference level is greater than the predetermined threshold value for less than the consecutive number of times. In an aspect, the sounding sequence protection component 220, the trigger component 240, the condition detection component 242, the protection component 246, the CTS2S component 248, the processor 203, and/or the transceiver 206 may selectively transmit the CTS2S frame on the selected bandwidth based on the determined interference level.

At block 606, the AP, such as the AP1 105-a, may initiate a sounding sequence based on the transmitted CTS2S frame. A processor, such as the processor 203, of the AP may initiate the sounding sequence on a bandwidth determined by a CCA for the CTS2S frame. The processor may initiate the sounding sequence on the selected bandwidth if the CCA for the CTS2S frame indicates that the selected bandwidth is available. The processor may select a different bandwidth than the selected bandwidth to initiate the sounding sequence based on the CCA for the CTS2S frame. The processor may initiate the sounding sequence on the selected different bandwidth if the CCA for the CTS2S frame indicates that the selected bandwidth is unavailable and the selected different bandwidth is available. The sounding sequence may comprise the AP transmitting a NDPA frame, and the AP transmitting a NDP frame. In an aspect, the sounding sequence protection component 220, the protection component 246, the CTS2S component 248, the sounding sequence component 256, the processor 203, and/or the transceiver 206 may initiate the sounding sequence based on the transmitted CTS2S frame.

The various operations of methods described above may be performed by any suitable means capable of performing the operations, such as various hardware or software component(s), circuits, or component(s). Generally, any operations illustrated in the Figures may be performed by corresponding functional means capable of performing the operations.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, flash memory, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Accordingly, an aspect of the disclosure can include a non-transitory computer-readable storage medium embodying a method for wireless communications. Accordingly, the disclosure is not limited to the illustrated examples.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. An access point for wireless communications, comprising:
a transceiver;
a memory; and
a processor communicatively coupled to the transceiver and the memory, the processor being configured to:
determine an interference level on a selected bandwidth;
selectively transmit, via the transceiver, a clear-to-send (CTS)-to-self frame on the selected bandwidth based on the determined interference level; and
initiate a sounding sequence based on the transmitted CTS-to-self frame.

2. The access point of claim 1, wherein the processor is configured to initiate the sounding sequence on a bandwidth determined by a clear channel assessment (CCA) for the CTS-to-self frame.

3. The access point of claim 1, wherein the processor is configured to select a different bandwidth than the selected bandwidth to initiate the sounding sequence based on a CCA for the CTS-to-self frame.

4. The access point of claim 1, wherein the sounding sequence comprises:
transmitting a null data packet announcement (NDPA) frame; and
transmitting a null data packet (NDP) frame.

5. The access point of claim 1, wherein the processor is configured to initiate a steering sequence after completion of the sounding sequence, the steering sequence being addressed to a plurality of stations (STAs) in a multi-user multiple-input-multiple-output (MU-MIMO) group.

6. The access point of claim 1, wherein the processor is configured to compare the determined interference level to a predetermined threshold value preprogrammed into the memory.

7. The access point of claim 6, wherein the processor is configured to enable the transmission of the CTS-to-self frame if the determined interference level is greater than the predetermined threshold value for a consecutive number of times preprogrammed into the memory.

8. The access point of claim 7, wherein the processor is configured to disable the transmission of the CTS-to-self frame if the determined interference level is less than the predetermined threshold value.

9. The access point of claim 8, wherein the processor is configured to disable the transmission of the CTS-to-self frame if the determined interference level is greater than the predetermined threshold value for less than the consecutive number of times.

10. The access point of claim 9, wherein the processor is configured to poll clear channel assessment (CCA) registers to determine the interference level on the selected bandwidth.

11. The access point of claim 10, wherein the determined interference level corresponds to a level of interference from a second access point transmitting on the selected bandwidth.

12. The access point of claim 11, wherein the processor is configured to set a value of an interference flag to one when the determined interference level is greater than the predetermined threshold value for the consecutive number of times.

13. The access point of claim 12, wherein the processor is configured to enable the transmission of the CTS-to-self frame when the value of the interference flag is set to one.

14. The access point of claim 13, wherein the processor is configured to bypass the transmission of the CTS-to-self frame when the value of the interference flag is set to zero.

15. A method for wireless communications, comprising:
determining, at an access point, an interference level on a selected bandwidth;
selectively transmitting, from the access point, a clear-to-send (CTS)-to-self frame on the selected bandwidth based on the determined interference level; and
initiating, at the access point, a sounding sequence based on the transmitted CTS-to-self frame.

16. The method of claim 15, further comprising initiating the sounding sequence on a bandwidth determined by a clear channel assessment (CCA) for the CTS-to-self frame.

17. The method of claim 15, further comprising selecting a different bandwidth than the selected bandwidth to initiate the sounding sequence based on a CCA for the CTS-to-self frame.

18. The method of claim 15, wherein initiating the sounding sequence further comprises:
transmitting a null data packet announcement (NDPA) frame; and
transmitting a null data packet (NDP) frame.

19. The method of claim 15, further comprising initiating a steering sequence after completion of the sounding sequence, the steering sequence being addressed to a plurality of stations (STAs) in a multi-user multiple-input-multiple-output (MU-MIMO) group.

20. The method of claim 15, further comprising comparing the determined interference level to a predetermined threshold value.

21. The method of claim 20, further comprising enabling the transmission of the CTS-to-self frame if the determined interference level is greater than the predetermined threshold value for a consecutive number of times.

22. The method of claim 21, further comprising disabling the transmission of the CTS-to-self frame if the determined interference level is less than the predetermined threshold value.

23. The method of claim 22, further comprising disabling the transmission of the CTS-to-self frame if the determined interference level is greater than the predetermined threshold value for less than the consecutive number of times.

24. The method of claim 23, further comprising polling clear channel assessment (CCA) registers to determine the interference level on the selected bandwidth.

25. The method of claim 24, wherein the determined interference level corresponds to a level of interference from a second access point transmitting on the selected bandwidth.

26. The method of claim 25, further comprising setting a value of an interference flag to one when the determined interference level is greater than the predetermined threshold value for the consecutive number of times.

27. The method of claim 26, further comprising enabling the transmission of the CTS-to-self frame when the value of the interference flag is set to one.

28. The method of claim 27, further comprising bypassing the transmission of the CTS-to-self frame when the value of the interference flag is set to zero.

29. A wireless communications device, comprising:
means for determining an interference level on a selected bandwidth;
means for selectively transmitting a clear-to-send (CTS)-to-self frame on the selected bandwidth based on the determined interference level; and
means for initiating a sounding sequence based on the transmitted CTS-to-self frame.

30. A non-transitory computer-readable storage medium storing instructions that, when executed by one or more processors of a wireless communications device, cause the wireless communications device to:
determine an interference level on a selected bandwidth;
selectively transmit a clear-to-send (CTS)-to-self frame on the selected bandwidth based on the determined interference level; and
initiate a sounding sequence based on the transmitted CTS-to-self frame.
